(19) United States
(12) Patent Application Publication
(10) Pub. No.: US 2024/0104119 A1
(43) Pub. Date: Mar. 28, 2024

(54) INFORMATION PROCESSING APPARATUS, CLASSIFICATION METHOD, AND STORAGE MEDIUM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 18/274,692

(22) PCT Filed: Mar. 31, 2021
(86) PCT No.: PCT/JP2021/013793

§ 371 Date: Jul. 27, 2023

(51) Int. Cl. G06F 16/28; G06F 16/2457

(52) U.S. Cl. CPC G06F 16/285; G06F 16/24578

(57) ABSTRACT

An information processing apparatus (1) includes: a data acquiring section (11) for acquiring target data, which is data to be classified into one of a plurality of categories; and a classifying section (12) for classifying the target data into one of the plurality of categories in accordance with a similarity between target relevant information relevant to the target data and category relevant information relevant to each of the plurality of categories, so that data is automatically classified without use of a classifier constructed by machine learning.

### TECHNICAL FIELD

The present invention relates to, for example, an information processing apparatus for classifying data which is to be classified under categories.

### BACKGROUND ART

Recently, a large amount of various kinds of data has been collected and accumulated, and the cost of classification performed for effectively utilizing the accumulated data has been increasing accordingly. A technique for reducing such cost is disclosed in, for example, Patent Literature 1 below. Patent Literature 1 below discloses an information processing apparatus for classifying, into various categories, product data regarding products or services for sale through networks.

More specifically, the information processing apparatus disclosed in Patent Literature 1 uses a classifier to determine a category, the classifier being trained with use of training data which is product data classified under hierarchical categories, so as to output a classification result which is a hierarchical category, with respect to a product indicated by inputted product data. With this information processing apparatus, it is possible to automatically classify product data and thus reduce the labor cost of classifying product data.

### CITATION LIST

### [Patent Literature]

### [Patent Literature 1]

Japanese Patent Application Publication, Tokukai, No. 2019-164402

### SUMMARY OF INVENTION

### Technical Problem

However, in a case of using a classifier constructed by machine learning, as in Patent Literature 1, there is a problem of being incapable of outputting a highly accurate classification result unless there is sufficient training data for each of the categories. An example object of an aspect of the present invention is to provide, for example, an information processing apparatus capable of automatically classifying data without use of a classifier constructed by machine learning.

### Solution to Problem

An information processing apparatus in accordance with an aspect of the present invention includes: a data acquiring means for acquiring target data, which is data to be classified into one of a plurality of categories; and a classifying means for classifying the target data into one of the plurality of categories in accordance with a similarity indicating an extent to which target relevant information relevant to the target data is similar to category relevant information relevant to each of the plurality of categories.

A classification method in accordance with an aspect of the present invention includes: at least one processor acquiring target data, which is data to be classified into one of a plurality of categories; and the at least one processor classifying the target data into one of the plurality of categories in accordance with a similarity indicating an extent to which target relevant information relevant to the target data is similar to category relevant information relevant to each of the plurality of categories.

A classification program in accordance with an aspect of the present invention causes a computer to function as: a data acquiring means for acquiring target data, which is data to be classified into one of a plurality of categories; and a classifying means for classifying the target data into one of the plurality of categories in accordance with a similarity indicating an extent to which target relevant information relevant to the target data is similar to category relevant information relevant to each of the plurality of categories.

### Advantageous Effects of Invention

With an aspect of the present invention, it is possible to automatically classify data without use of a classifier constructed by machine learning.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a process flow of a classification method in accordance with the first example embodiment of the present invention.

FIG. 3 is a block diagram illustrating a configuration of an information processing apparatus in accordance with a second example embodiment of the present invention.

FIG. 4 is a flowchart illustrating a process flow of the classification method carried out by the information processing apparatus.

FIG. 5 is a diagram illustrating an example of classification of target data, the classification being carried out by the information processing apparatus.

FIG. 6 is a block diagram illustrating a configuration of an information processing apparatus in accordance with a third example embodiment of the present invention.

FIG. 7 is a diagram illustrating an example of similarity calculation based on web search results, the similarity calculation being carried out by the information processing apparatus.

FIG. 8 is a diagram illustrating an example of similarity calculation base on a similarity between web pages detected in a web search, the similarity calculation being carried out by the information processing apparatus.

FIG. 9 is a block diagram illustrating a configuration of an information processing apparatus in accordance with a fourth example embodiment of the present invention.

FIG. 10 is a diagram illustrating an example of overall similarity calculation carried out by the information processing apparatus.

FIG. 11 is a flowchart illustrating a process flow of a classification method carried out by the information processing apparatus.

FIG. 12 is a diagram illustrating an example of a computer that executes the instructions of a program that is software for implementing the functions of the information processing apparatus in accordance with each of the example embodiments of the present invention.

### EXAMPLE EMBODIMENTS

### First Example Embodiment

The following description will discuss a first example embodiment of the present invention in detail, with reference to the drawings. The first example embodiment is basic to the example embodiments that will be described later.

### (Configuration of Information Processing Apparatus 1)

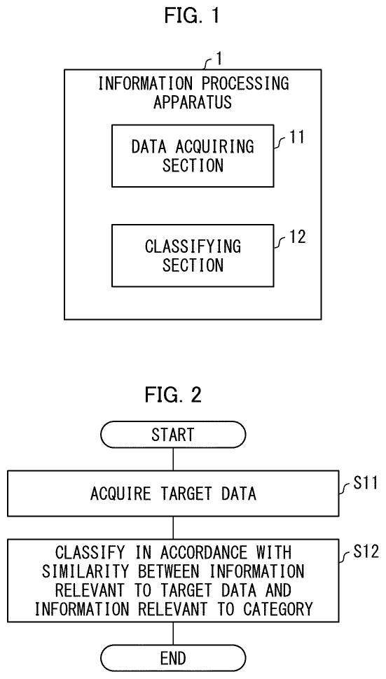

The configuration of an information processing apparatus 1 in accordance with the first example embodiment will be described below, with reference to FIG. 1. FIG. 1 is a block diagram illustrating a configuration of the information processing apparatus 1. The information processing apparatus 1 includes a data acquiring section 11 and a classifying section 12, as illustrated in FIG. 1.

The data acquiring section 11 acquires target data. The target data is data to be classified into one of a plurality of categories.

The classifying section 12 classifies the target data into one of the plurality of categories in accordance with a similarity indicating an extent to which target relevant information relevant to the target data is similar to category relevant information relevant to each of the plurality of categories.

As above, a configuration employed in the information processing apparatus 1 in accordance with the first example embodiment is the configuration in which included are: a data acquiring means for acquiring target data, which is data to be classified into one of a plurality of categories; and a classifying means for classifying the target data into one of the plurality of categories in accordance with a similarity indicating an extent to which target relevant information relevant to the target data is similar to category relevant information relevant to each of the plurality of categories.

When target relevant information relevant to the target data is similar to category relevant information relevant to a category, the target data is highly likely to match the category. Accordingly, with the above configuration, in which the target data is classified in accordance with the similarity between the target relevant information and the category relevant information, it is possible to classify the target data into an appropriate category. In addition, the above configuration eliminates the need to use a classifier constructed by machine learning. Thus, with the information processing apparatus 1 in accordance with the first example embodiment, it is possible to obtain an example advantage of being capable of automatically classifying the target data without use of a classifier constructed by machine learning.

### (Transformation Pattern Determination Program)

The above functions of the information processing apparatus 1 can be implemented via a program. A configuration employed in a classification program in accordance with the first example embodiment is the configuration in which the classification program causes a computer to function as: a data acquiring means for acquiring target data, which is data to be classified into one of a plurality of categories; and a classifying means for classifying the target data into one of the plurality of categories in accordance with a similarity indicating an extent to which target relevant information relevant to the target data is similar to category relevant information relevant to each of the plurality of categories. Accordingly, with the classification program in accordance with the first example embodiment, it is possible to obtain an example advantage of being capable of automatically classifying the target data without use of a classifier constructed by machine learning.

### (Process Flow of Classification Method)

The process flow of a classification method in accordance with the present example embodiment will be described below, with reference to FIG. 2. FIG. 2 is a flowchart illustrating the process flow of the classification method. Each of the steps of this classification method may be carried out by a processor included in the information processing apparatus 1 or a processor included in another apparatus. Alternatively, the steps may be carried out by respective processors provided in different apparatuses.

In S11, at least one processor acquires target data, which is data to be classified into one of a plurality of categories.

In S12, the at least one processor classifies the target data into one of the plurality of categories in accordance with a similarity indicating an extent to which target relevant information relevant to the target data is similar to category relevant information relevant to each of the plurality of categories.

As above, a configuration employed in the classification method in accordance with the present example embodiment is the configuration in which the classification method includes: at least one processor acquiring target data, which is data to be classified into one of a plurality of categories; and the at least one processor classifying the target data into one of the plurality of categories in accordance with a similarity indicating an extent to which target relevant information relevant to the target data is similar to category relevant information relevant to each of the plurality of categories. Accordingly, with the classification method in accordance with the first example embodiment, it is possible to obtain an example advantage of being capable of automatically classifying the target data without use of a classifier constructed by machine learning.

### Second Example Embodiment

### (Configuration of Information Processing Apparatus 2)

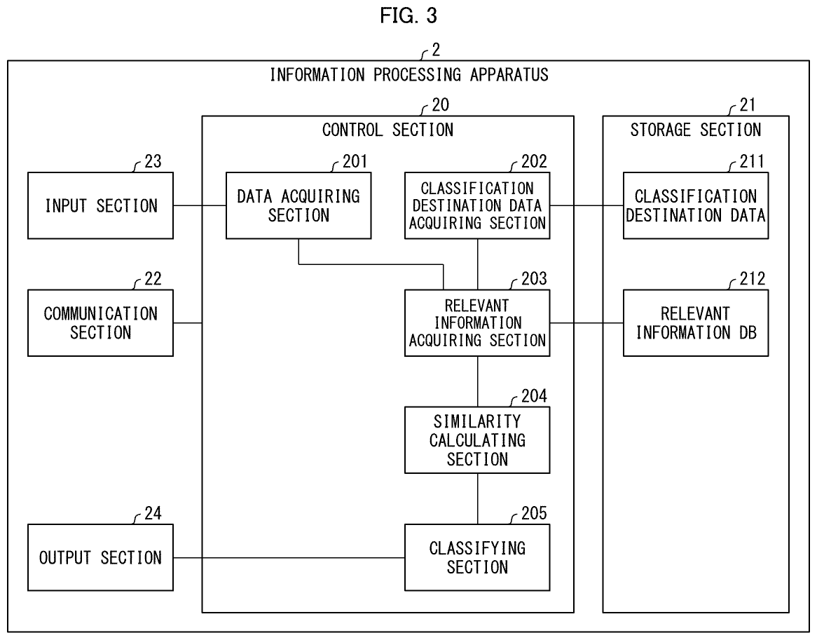

The configuration of an information processing apparatus 2 in accordance with a second example embodiment will be described below on the basis of FIG. 3. FIG. 3 is a block diagram illustrating a configuration of the information processing apparatus 2. As is illustrated, the information processing apparatus 2 includes: a control section 20 that has the overall control of the sections of the information processing apparatus 2; and a storage section 21 that stores various kinds of data used by the information processing apparatus 2. The information processing apparatus 2 further includes: a communication section 22 via which the information processing apparatus 2 communicates with another apparatus; an input section 23 that accepts input of various kinds of data to the information processing apparatus 2; and an output section 24 via which the information processing apparatus 2 outputs various kinds of data.

The control section 20 includes: a data acquiring section 201; a classification destination data acquiring section 202; a relevant information acquiring section 203; a similarity calculating section 204; and a classifying section 205. The storage section 21 stores classification destination data 211 and a relevant information DB 212.

The data acquiring section 201 acquires target data, which is data to be classified into one of a plurality of categories. The target data may be any data provided that the data can be the object of classification, and may be, for example, text data, image data, or voice data. The target data may be, for example, an item name or the like that is contained in a database or a data table.

The classification destination data acquiring section 202 acquires the classification destination data 211 indicating a plurality of categories which are classification destinations under which the target data is classified, and identifies a category which is a candidate classification destination of the target data. The categories of the classification destinations are not limited to any particular categories. What is only needed is to predetermine, in the classification destination data 211, categories appropriate for classification destinations of the target data.

The categories of the classification destinations may be in a hierarchical form. In this case, the classification destination data 211 should be data indicating each of the categories of the classification destinations and the hierarchical level of that category (e.g., large classification, middle classification, small classification).

The relevant information acquiring section 203 acquires target relevant information. The target relevant information is information relevant to the target data. The target relevant information only needs to be information relevant to the target data. According to the second example embodiment, an example will be discussed in which a search result of search for information on the target data is acquired as the target relevant information. More specifically, the relevant information acquiring section 203 searches the relevant information DB 212 for information on the target data, and acquires information which has been detected and which is to be used as the target relevant information.

The relevant information DB 212 is a database which stores various kinds of information that are likely to be relevant to the target data. In the relevant information DB 212, information corresponding to the target data may be provided in advance. Note that the relevant information DB 212 may be stored in an apparatus external to an information processing apparatus 2A.

For example, in a case where the target data is text data indicating the name of a product, the relevant information DB 212 that stores the various kinds of text data of, for example, descriptions of various products and reviews of the various products may be used. Besides this, for example, a database or data lake of a company that handles a product or a service relevant to the target data may be used as the relevant information DB 212.

In addition, for example, a database which stores data extracted by data enrichment that is carried out with respect to various kinds of data regarding various products and services that can be relevant to the target data may be used as the relevant information DB 212. Data enrichment is a service for increasing the use value of data to be subjected to data enrichment, by extracting various kinds of information relevant to the data and treating the various kinds of information as additional information of the data. In this case, the category determined by the information processing apparatus 2 may be added to the relevant information DB 212 as information relevant to the target data. In this case, it can be said that the information processing apparatus 2 is for carrying out data enrichment of the target data.

In a case where the target data is image data, the relevant information acquiring section 203 may search the relevant information DB 212 for an image similar to the target data and/or text data relevant to the target data.

The relevant information acquiring section 203 acquires category relevant information. The category relevant information is information relevant to a category. The category relevant information only needs to be information relevant to the corresponding category. According to the second example embodiment, an example will be discussed in which the relevant information DB 212 is searched for information relevant to a category, as with the target data described above, and the search result is acquired as the category relevant information. Note that the search for information on the target data and the search for information on categories may be carried out within the same relevant information DB 212, or may be carried out within the respective relevant information DBs 212 the data of which is different from each other.

The similarity calculating section 204 calculates a similarity indicating a degree to which the search result indicated by the target relevant information is similar to the search result indicated by the category relevant information. Note that the method of calculating the similarity of the search result will be described below in the third example embodiment.

The classifying section 205 classifies the target data into one of a plurality of categories in accordance with the similarity calculated by the similarity calculating section 204, that is, a similarity indicating an extent to which the target relevant information relevant to the target data is similar to the category relevant information relevant to each of the plurality of categories. Specifically, the classifying section 205 classifies the target data into a category, the category being included in the plurality of categories which are the candidate classification destinations of the target data and corresponding to the category relevant information for which the above-described similarity is the highest.

As described above, a configuration employed in the information processing apparatus 2 in accordance with the second example embodiment is the configuration in which the information processing apparatus 2 includes: a relevant information acquiring section 203 that acquires a search result of search for information on the target data and also acquires a search result of search for information on a category, the search result of search for information on the target data being target relevant information, the search result of search for information on a category being category relevant information; and a similarity calculating section 204 that calculates a similarity indicating a degree to which the search result indicated by the target relevant information is similar to the search result indicated by the category relevant information, and the classifying section 205 classifies the target data into a category corresponding to the category relevant information for which the similarity is the highest.

Since the search result of search for the target data is relevant to the target data, the search result is reasonable information as the target relevant information. The search result of search for a category is also reasonable information as category relevant information. Further, it is possible to quantify, in the form of a numerical value, the extent to which these search results are similar to each other. The numerical value is a similarity. Accordingly, with the information processing apparatus 2 in accordance with the second example embodiment, it is possible to obtain an example advantage of being capable of appropriately classifying the target data, in addition to the example advantage yielded by the information processing apparatus 1 in accordance with the first example embodiment.

### (Process Flow of Classification Method)

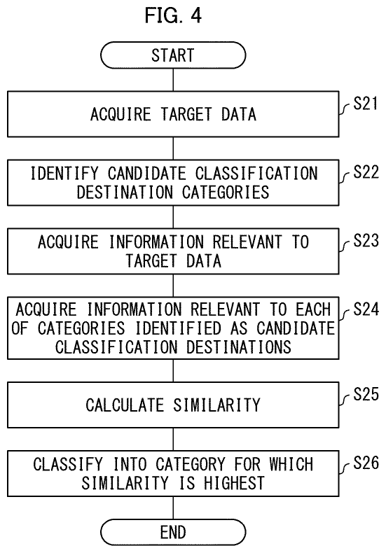

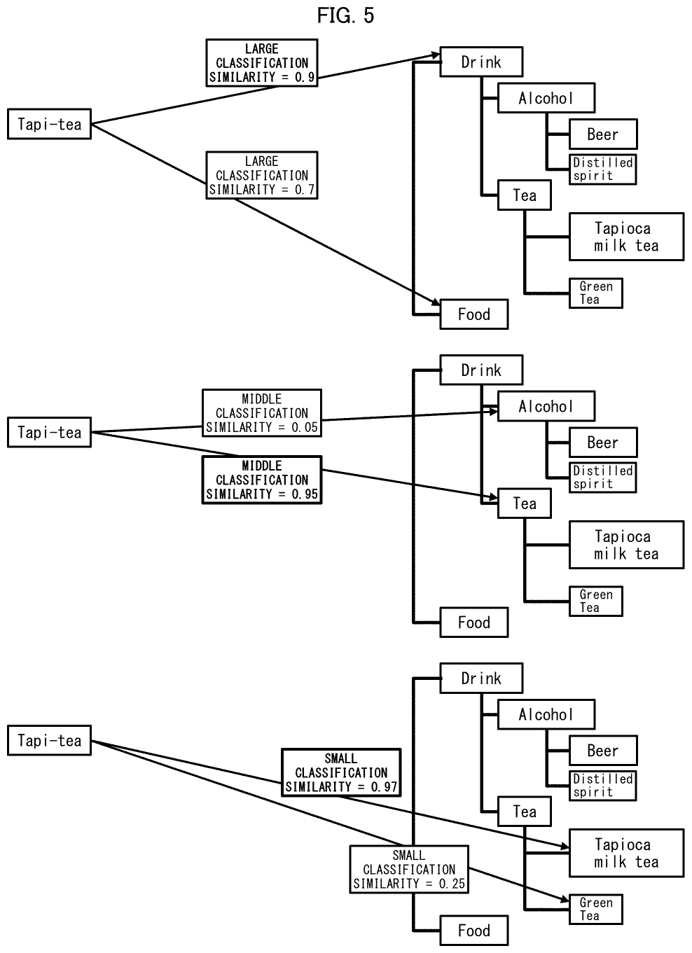

The process flow of a classification method in accordance with the second example embodiment will be described with reference to FIG. 4. FIG. 4 is a flowchart illustrating a process flow of the classification method carried out by the information processing apparatus 2. In the following description, FIG. 5 illustrating an example of the classification will also be described.

In S21, the data acquiring section 201 acquires target data, which is data to be classified into one of a plurality of categories. For example, in the example illustrated in FIG. 5, the data acquiring section 201 acquires text data of the word (product name) “Tapi-tea” which is the target data.

In S22, the classification destination data acquiring section 202 acquires the classification destination data 211 stored in the storage section 21, and identifies a category which is a candidate classification destination of the target data acquired in S21. For example, in the example illustrated in FIG. 5, in a case where the target data “Tapi-tea” is classified into the large classification, the classification destination data acquiring section 202 identifies “Drink” and “Food”, which are categories of the large classification, from among the categories indicated in the classification destination data 211 and ranging from the large classification to the small classification.

In S23, the relevant information acquiring section 203 searches the relevant information DB 212 for information relevant to the target data acquired in S21. The search result obtained in this search is acquired as the target relevant information. For example, in the example illustrated in FIG. 5, in a case of searching the relevant information DB 212 that stores text data of product information, reviews, etc. regarding various products, the product information and reviews that contain the character string “Tapi-tea” are detected, and the text data of such product information and/or reviews is acquired as the target relevant information. Note that this search is not limited to a full match search of text data, but may be a partial match search of the text data. For example, if the text data is “Tapi-tea”, a search by a character string “Tapi” or “Tea” obtained by dividing the character string may be carried out.

In S24, the relevant information acquiring section 203 searches the relevant information DB 212 for information relevant to each of the categories indicated in the classification destination data acquired in S22. Each search result obtained in this search is acquired as the category relevant information of the corresponding category. For example, in the example illustrated in FIG. 5, in a case of searching the relevant information DB 212 that stores text data of product information, reviews, etc. of various products, the product information and reviews that contain the character string “Drink” are detected, and the texts of such product information and reviews are acquired as the category relevant information. Similarly, with a search by the character string “Food”, product information and reviews that contain this character string are detected, and the texts of such product information and reviews are also acquired as the category relevant information. Note that the process of S24 may be carried out prior to the process of S23, or may be carried out in parallel with the process of S23.

In S25, the similarity calculating section 204 calculates a similarity indicating a degree to which the search result indicated by the target relevant information acquired in S23 is similar to the search result indicated by the category relevant information acquired in S24 are similar. This process is carried out for each of the categories identified in S22. For example, in the example illustrated in FIG. 5, the similarity between the search result of “Tapi-tea” and the search result of “Drink” is calculated as 0.9, and the similarity between the search result of “Tapi-tea” and the search result of “Food” is calculated as 0.7.

In S26, the classifying section 205 classifies the target data into the category for which the similarity calculated by the similarity calculating section 204 is the highest. For example, in the example illustrated in FIG. 5, the similarity between the search result of “Tapi-tea” and the search result of “Drink” is 0.9, and the similarity between the search result of “Tapi-tea” and the search result of “Food” is 0.7. Thus, “Tapi-tea” is classified into the large classification “Drink”. The classifying section 205 causes the output section 24 to output the calculated similarity. With this, the classification method illustrated in FIG. 4 ends. The calculated similarity may be transmitted to another apparatus via the communication section 22 so that the other apparatus outputs the calculated similarity, or the calculated similarity may be stored in the storage section 21.

Note that, in a case where there is further classification destinations subordinate to the classification destination identified in the classification in S26, classification into the subordinate classification destinations may follow the process of S26. In this case, the processing returns to the process of S22 after the process of S26 ends, and categories which are candidate subordinate classification destinations are identified in S22. Subsequently, the processes of S23 to S26 are carried out so that the subordinate classification destination category is determined.

For example, in the example illustrated in FIG. 5, after determining that the large classification of “Tapi-tea” is “Drink”, “Alcohol” and “Tea”, which are categories of the middle classification subordinate to “Drink”, are selected as candidate classification destinations. Then, the similarity between the search result of “Tapi-tea” and the search result of “Alcohol” is calculated as 0.05, and the similarity between the search result of “Tapi-tea” and the search result of “Tea” is calculated as 0.95. Thus, it is determined that the middle classification of “Tapi-tea” is “Tea”. In determining the subordinate category, it is not necessary to carry out the process of S23 again, and the target relevant information acquired when the upper-level category is determined may be used as is.

In addition, since there are “Tapioca milk tea” and “Green Tea”, which are categories of the small classification further subordinate to the middle classification “Tea”, these categories become candidate classification destinations for the next classification. Then, the similarity between the search result of “Tapi-tea” and the search result of “Tapioca milk tea” is calculated as 0.97, and the similarity between the search result of “Tapi-tea” and the search result of “Green Tea” is calculated as 0.25. Thus, it is determined that the small classification of “Tapi-tea” is “Tapioca milk tea”. The above processes provide a reasonable classification result for the target data “Tapi-tea”, the result being such that the large classification is “Drink”, the middle classification is “Tea”, and the small classification is “Tapioca milk tea”.

Although determinations are made in descending order of the level of category in the above example, but the determinations may be made in ascending order of the level of category. In the case where the determinations are made in the ascending order of the level of category, a large number of categories are identified in S22 as candidate classification destinations. It is therefore necessary to acquire the relevant information of each of those large number of categories in S24. At the same time, if the lower-level category is determined, the upper-level category is automatically determined. In this case, it is not necessary to repeat the processes of S22 to S26 in FIG. 4 a plurality of times.

In addition, the determined categories of the respective hierarchical levels can differ between the case in which categories are determined in the descending order of level and the case in which categories are determined in the ascending order of level. In view of this, for example, the information processing apparatus 2 may carry out both the process of determining categories in the descending order of level and the process of determining categories in the ascending order of level, and may output categories of the respective hierarchical levels determined in each of the processes. In this case, the user of the information processing apparatus 2 may use, as the final category, one of the outputted categories that is judged by the user as reasonable.

### Third Example Embodiment

The following description will discuss a third example embodiment of the present invention in detail, with reference to the drawings. The same reference sign is assigned to a component that has the same function as the component described in the second example embodiment, and the description thereof is not repeated.

### (Configuration of Information Processing Apparatus 2A)

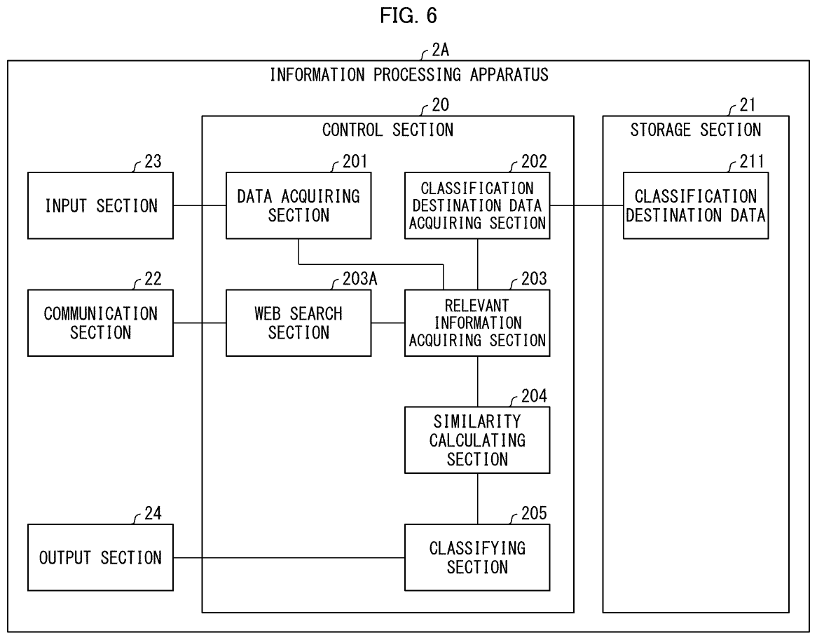

The configuration of an information processing apparatus 2A in accordance with the third example embodiment will be described below, with reference to FIG. 6. FIG. 6 is a block diagram illustrating a configuration of the information processing apparatus 2A. The information processing apparatus 2A is different from the information processing apparatus 2 illustrated in FIG. 3 in that the information processing apparatus 2A includes a web search section 203A and the relevant information DB 212 is not stored in the storage section 21.

The web search section 203A conducts a web search for information on the target data, and outputs the search result to the relevant information acquiring section 203. That is, in the third example embodiment, the target relevant information acquired by the relevant information acquiring section 203 is the result of the web search for information on the target data, conducted by the web search section 203A. Note that the search method is not limited to any particular method. For example, in the case of a search by text data, the web search section 203A may conduct a full match search, or may conduct a partial match search. In addition, for example, in a case where the target data is image data, the web search section 203A may search for an image similar to the image data.

Similarly, the web search section 203A conducts a web search for information on each of the categories which are candidate classification destinations of the target data, and outputs the search result to the relevant information acquiring section 203. That is, in the third example embodiment, the category relevant information acquired by the relevant information acquiring section 203 is the result of web search for information on each of the categories, conducted by the web search section 203A.

Accordingly, in the third example embodiment, the similarity calculating section 204 calculates a similarity indicating a degree to which a web search result, indicated by the target relevant information, of the target data is similar to a web search web search result, indicated by the category relevant information, of each of the categories.

### (Overview of Similarity Calculation Method)

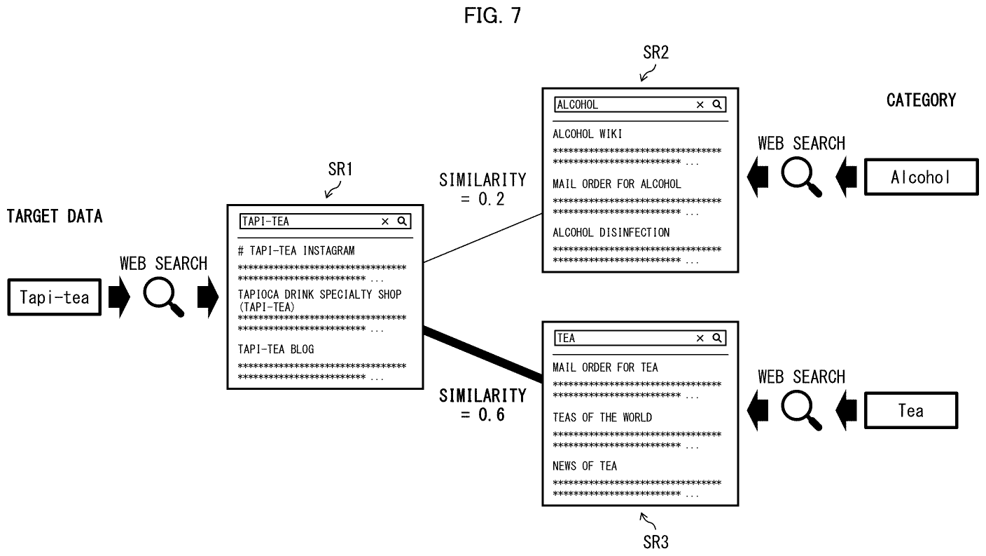

An outline of a similarity calculation method in accordance with a third example embodiment will be described below, with reference to FIG. 7. FIG. 7 is a diagram illustrating an example of similarity calculation based on web search results. More specifically, FIG. 7 illustrates an example in which the target data is “Tapi-tea” and the candidate classification destination are the categories “Alcohol” and “Tea”.

In the example illustrated in FIG. 7, the web search section 203A conducts a web search for information on “Tapi-tea”, which is the target data. The search result is illustrated as SR1 in FIG. 7. As shown in SR1, various web pages that contain the character string “Tapi-tea” are detect through the web search.

Similarly, in the example illustrated in FIG. 7, the web search section 203A also conducts a web search for information on each of the categories “Alcohol” and “Tea”, which are the candidate classification destinations. FIG. 7 illustrates the respective search results as SR2 and SR3. As illustrated in SR2 and SR3, through the web searches, various web pages that contain the character string “Alcohol” are detected, and various web pages that contains the character string “Tea” are detected as well.

Each of the search results as described above is outputted to the relevant information acquiring section 203, and the relevant information acquiring section 203 acquires target relevant information and category relevant information (hereinafter, these kinds of information are referred to collectively and simply as relevant information) from the outputted search results. Note that the relevant information acquiring section 203 does not need to treat, as the relevant information, all of the results of detection by the web search section 203A, and only needs to acquire the search results necessary for calculating the similarity to treat the same as the relevant information. For example, the relevant information acquiring section 203 may acquire a predetermined number of high-ranking ones of the search results detected by the web search section 203A to treat the same as relevant information.

The similarity calculating section 204 uses the relevant information acquired by the relevant information acquiring section 203 to calculate the similarity. In the example illustrated in FIG. 7, the similarity between the search result of the target data “Tapi-tea” and the search result of the category “Alcohol” is calculated as 0.2, and the similarity between the search result of the target data “Tapi-tea” and the search result of the category “Tea” is calculated as 0.6. In this case, the classifying section 205 classifies the target data “Tapi-tea” into the category “Tea”, for which the similarity is higher.

### (Details of Similarity Calculation Method)

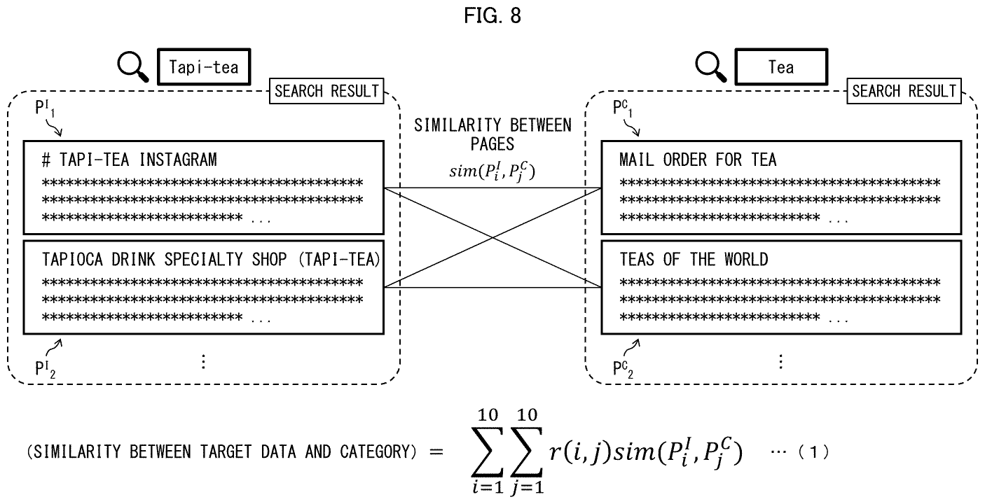

Next, details of a calculation method carried out by the similarity calculating section 204 will be described below on the basis of FIG. 8. FIG. 8 is a diagram illustrating an example of similarity calculation base on a similarity between web pages detected in a web search.

FIG. 8 illustrates a web page P^{I}₁ detected as the highest-ranking search result and a web page P^{I}₂ detected as the second highest-ranking search result, of the search results of the target data “Tapi-tea”. FIG. 8 illustrates a web page P^{C}₁, which is the highest-ranking search result and a web page P^{C}₂, which is the second highest-ranking search result, of the search results of the category “Tea”.

The similarity calculating section 204 may use a similarity sim(P^{I}ᵢ, P^{C}ⱼ) between the detected web pages to calculate a similarity between the search result of the target data “Tapi-tea” and the search result of the category “Tea”.

For example, the similarity calculating section 204 may calculate a degree to which the web pages or documents for which a similarity is calculated overlap each other in terms of the words used therein, the domain names thereof, or the words used in the file paths thereof, to treat the degree as the similarity sim(P^{I}ᵢ, P^{C}ⱼ) between the web pages. For example, the degree of overlap may be calculated with use of Jaccard-Index. In this case, the similarity sim(P^{I}ᵢ, P^{C}ⱼ) between the web pages is expressed as the following mathematical formula.

sim (P^{I}ᵢ, P^{C}ⱼ)=J(bow(P^{I}ᵢ), bow(P^{C}ⱼ))

Note that bow(P^{I}ᵢ) is a multi-set consisting of the word count values of the web pages P^{I}ᵢ. Similarly, bow (P^{C}ⱼ) is a multi-set consisting of the word count values of the web pages P^{C}ⱼ. As a matter of course, Jaccard-Index is merely an example, and any technique for calculating a similarity between sets obtained from search results can be applied.

The similarity calculating section 204 may use the similarity between the web pages, which is calculated as described above to calculate a similarity between the target data and the category (more precisely, a similarity between the target relevant information and the category relevant information) from Formula (1) illustrated in FIG. 8. The term r(i,j) in Formula (1) is a weight. Specifically, in a case of using Formula (1), the similarity calculating section 204 carries out an operation of multiplying the similarity between web pages by the weight r(i,j) corresponding to the search rankings of the web pages, with respect to all combinations of the search rankings ranging from first to tenth, and calculates the sum of the operation results, to treat the sum as the similarity between the target relevant information and the category relevant information.

As a matter of course, multiplying by a weight is not essential. However, by multiplying by a weight, it is possible to increase the accuracy with which a reasonable similarity is calculated. Thus, multiplying by a weight is preferable. For example, the weight assigned to the extent of similarity between high-ranking search results may be greater than the weight assigned to the extent of similarity between low-ranking search results. This is because high-ranking search results are often deeply relevant to the target data and/ or the category than low-ranking search results. Specifically, an example of the weight may be r(i,j)=(1/i)·(1/j).

The similarity calculation method illustrated in FIGS. 7 and 8 can be similarly applied to calculation of the similarity between search results of searching the relevant information DB 212.

Here, if the web or the relevant information DB 212 is searched, there is a possibility of obtaining various search results that range from those deeply relevant to the target data and/or the category to those poorly relevant to the target data and/or the category. Accordingly, when the search results contained in the target relevant information and the category relevant information are all poorly relevant to the target data and/or the category, there is a possibility that a reasonable similarity will not be calculated.

To address this, the information processing apparatus 2A in accordance with the third example embodiment uses the target relevant information indicating search results ranging from a high-ranking search result to a low-ranking search result, the search results being obtained by searching for information on the target data, as described above. In addition, the information processing apparatus 2A uses the category relevant information indicating search results that range from a high-ranking search result to a low-ranking search result, the search results being obtained by searching for information on the category. Specifically, a configuration employed in the similarity calculating section 204 is the configuration in which the similarity is calculated in accordance with an extent to which each of the search results that are indicated by the target relevant information and that range from the high-ranking search result to the low-ranking search result is similar to each of the search results that are indicated by the category relevant information and that range from the high-ranking search result to the low-ranking search result.

Accordingly, with the information processing apparatus 2A in accordance with the second example embodiment, it is possible to obtain an example advantage of being capable of increasing the accuracy of the similarity by increasing the possibility that search results highly relevant to the target data and/or the category are contained in the target relevant information and the category relevant information, in addition to the example advantage yielded by the information processing apparatus 1 in accordance with the first example embodiment. In addition, even in a case where the target relevant information and the category relevant information contain search results that are poorly relevant to the target data and/or the category, it is possible to calculate a reasonable similarity as a whole.

As above, a configuration employed in the information processing apparatus 2A in accordance with the third example embodiment may be the configuration in which, in calculating the similarity, the similarity calculating section 204 assigns a greater weight to the extent of the similarity between high-ranking search results than to the extent of the similarity between low-ranking search results.

High-ranking search results are often deeply relevant to the target data or category than low-ranking search results. Accordingly, with the information processing apparatus 2A in accordance with the third example embodiment, it is possible to obtain an example advantage of being capable of increasing the accuracy with which a reasonable similarity is calculated, in addition to the example advantage yielded by the information processing apparatus 1 in accordance with the first example embodiment.

### Fourth Example Embodiment

The following description will discuss a third example embodiment of the present invention in detail, with reference to the drawings. The same reference sign is assigned to a component that has the same function as the component described in the third example embodiment, and the description thereof is not repeated.

### (Configuration of Information Processing Apparatus 2B)

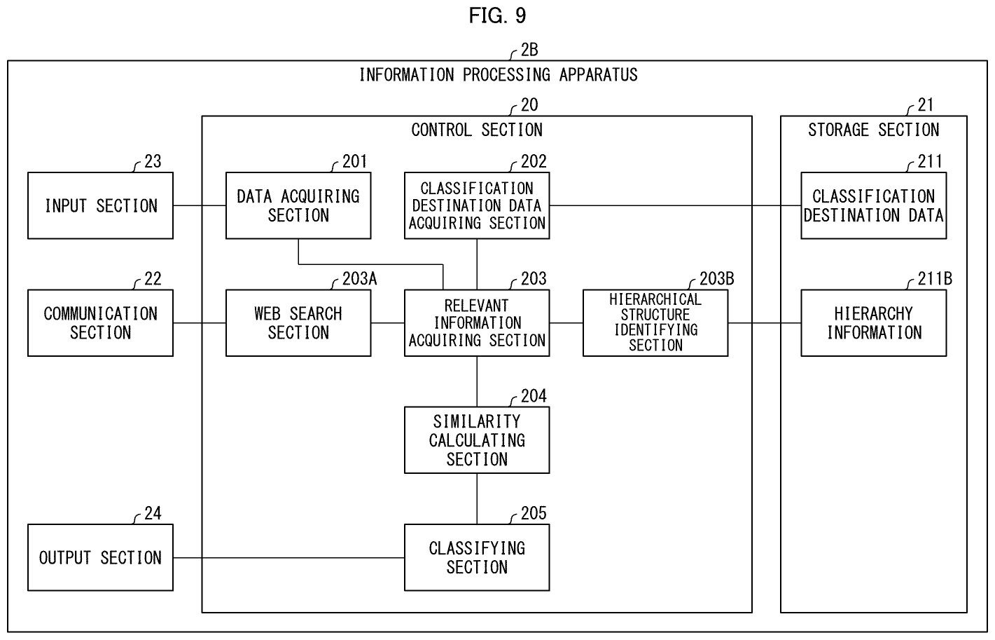

The configuration of an information processing apparatus 2B in accordance with the fourth example embodiment will be described below, with reference to FIG. 9. FIG. 9 is a block diagram illustrating a configuration of the information processing apparatus 2B. The information processing apparatus 2B is different from the information processing apparatus 2A illustrated in FIG. 6 in that it includes a hierarchical structure identifying section 203B and that hierarchy information 211B is stored in the storage section 21.

The hierarchical structure identifying section 203B determines the upper-level category of each of the categories which are candidate classification destinations, in accordance with the hierarchy information 211B indicating the hierarchical structure of the categories. Specifically, the hierarchy information 211B indicates the upper-level category and the lower-level category of each of the categories indicated in the classification destination data 211. Note that only a lower-level category is indicated for the top-level category, and only an upper-level category is indicated for the bottom-level category. Thus, the hierarchical structure identifying section 203B can identify the upper-level category of each of the categories which are the candidate classification destinations acquired by the classification destination data acquiring section 202, by referring to the hierarchy information 211B.

In the fourth example embodiment, the web search section 203A conducts a web search for information on the target data and information on each of the categories that are the candidate classification destinations of the target data, and also conducts a web search of information on the upper-level category of that category, and outputs the results of these searches to the relevant information acquiring section 203. Accordingly, the relevant information acquiring section 203 of the fourth example embodiment acquires upper-level category relevant information, which is information relevant to the upper-level categories of the categories, in addition to the target relevant information and the category relevant information.

The similarity calculating section 204 calculates the similarity between the target relevant information and the category relevant information and also calculates an upper-level similarity, which indicates an extent to which the target relevant information is similar to the upper-level category relevant information. The classifying section 205 classifies the target data in accordance with the similarity and the upper-level similarity which are calculated as described above. More specifically, the similarity calculating section 204 calculates an overall similarity from the similarity and the upper-level similarity, and the classifying section 205 then classifies the target data in accordance with this overall similarity.

### (Method of Overall Similarity Calculation)

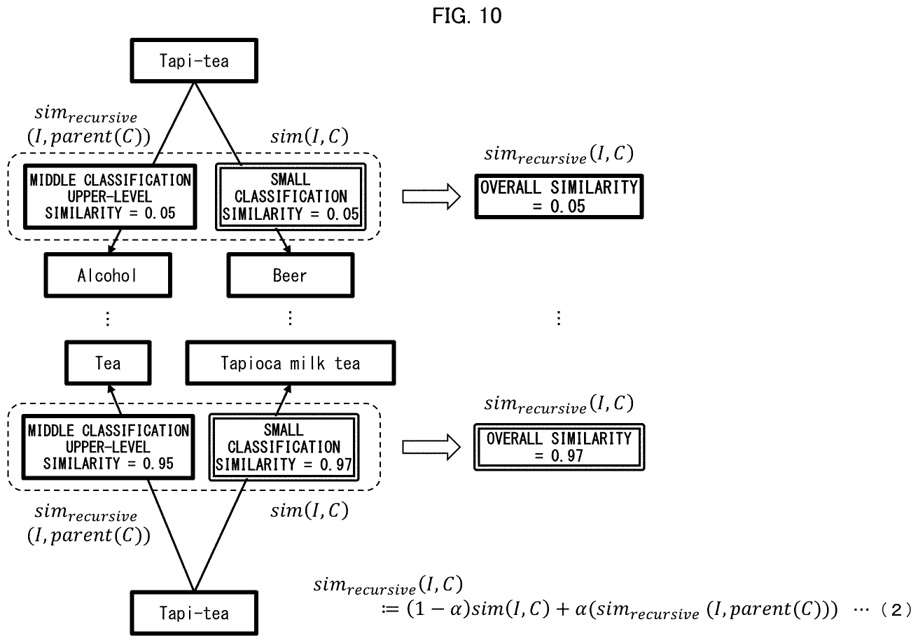

A method of overall similarity calculation will be described with reference to FIG. 10. FIG. 10 is a diagram illustrating an example of overall similarity calculation. In this example, the target data is “Tapi-tea”, and the candidate classification destinations are “Beer” and “Tapioca milk tea”, which are categories of the small classification.

In this example, the classification destination data acquiring section 202 acquires, from the classification destination data 211, the small classification categories “Beer” and “Tapioca milk tea”, which are candidate classification destinations. The hierarchical structure identifying section 203B then identifies the upper-level category of “Beer” as “Alcohol” and identifies the upper-level category of “Tapioca milk tea” as “Tea”. Note that the hierarchical structure identifying section 203B may identify categories that are further higher in level than the upper-level categories.

Next, the web search section 203A conducts a web search for information on each of the following: the target data “Tapi-tea”; candidate classification destination categories “Beer” and “Tapioca milk tea”; and the upper-level categories “Alcohol” and “Tea” respectively of “Beer” and “Tapioca milk tea”. The relevant information acquiring section 203 acquires target relevant information, category relevant information, and upper-level category relevant information, which indicate the results of these searches.

Next, the similarity calculating section 204 calculates a similarity sim(I,C) between the target relevant information and the category relevant information, and also calculates an upper-level similarity sim_{recursive}(I,parent(C)), which is the similarity between the target relevant information and the upper-level category relevant information.

In the example illustrated in FIG. 10, the similarity sim(I,C) between the target relevant information on “Tapi-tea” and the category relevant information on “Beer” is calculated as 0.05, and the upper-level similarity sim_{recursive}(I,parent(C)) between the target relevant information on “Tapi-tea” and the category relevant information on “Alcohol” (the upper-level category of “Beer”) is calculated as 0.05. In addition, the similarity sim(I,C) between the target relevant information on “Tapi-tea” and the category relevant information on “Tapioca milk tea” is calculated as 0.97, and the upper-level similarity sim_{recursive}(I,parent(C)) between the target relevant information on “Tapi-tea” and the upper-level category relevant information on “Tea” (the upper-level category of “Tapioca milk tea”) is calculated as 0.95.

The similarity calculating section 204 may calculate an overall similarity sim_{recursive}(I,C) from Formula (2) illustrated in FIG. 10. Note that a in Formula (2) is a weight value set between 0 and 1. In a case of using Formula (2), if a is less 5 than 0.5, the weight assigned to the similarity sim(I,C) between the target relevant information and the category relevant information is greater than the weight assigned to the upper-level similarity sim_{recursive}(I,parent(C)) between the target relevant information and the upper-level category relevant information. Therefore, α is preferably less than 0.5. In addition, a weight assigned to a category that is higher in level than the upper-level category is preferably lower than the weight assigned to the upper-level category. This enables a category closer to a candidate classification destination category to have a higher degree of influence.

For example, when α=0.2, the overall similarity between “Tapi-tea” and “Beer” is as follows: sim_{recursive}(I,C)=0.8×0.05+0.2×0.05=0.05. Similarly, the overall similarity between “Tapi-tea” and “Tapioca milk tea” is as follow: sim_{recursive}(I,C)=0.8×0.97+0.2×0.95=0.97.

The classifying section 205 classifies the target data in accordance with the overall similarity thus calculated for each of the categories. In the example illustrated in FIG. 10, the classifying section 205 classifies “Tapi-tea” into “Tapioca milk tea”, for which the overall similarity is higher.

### (Process Flow of Classification Method)

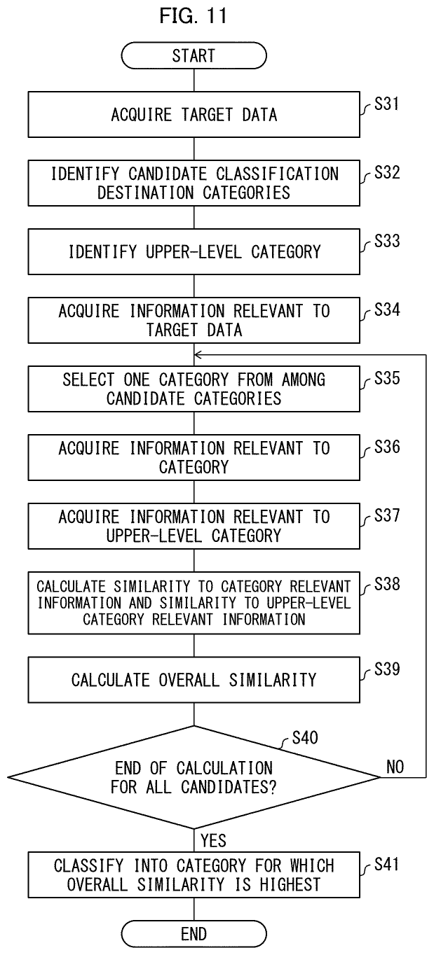

The process flow of a classification method in accordance with the fourth example embodiment will be described with reference to FIG. 11. FIG. 11 is a flowchart illustrating a process flow of a classification method carried out by the information processing apparatus 2B. Since S31 and S32 are the same as S21 and S22 in FIG. 4, the descriptions thereof will not be repeated here.

In S33, the hierarchical structure identifying section 203B identifies the upper-level category of each of the categories identified in S32, in accordance with the hierarchy information 211B. Note that the hierarchical structure identifying section 203B may identify a category that is higher than each of the identified upper-level categories, if any. This process may also be repeated until the top-level category is identified. For example, in a case where three hierarchical categories which are the large classification, the middle classification, and the small classification are defined, when small classification categories are identified in S32, the hierarchical structure identifying section 203B identifies at least a middle classification category, and may further identify a large classification category. In a case where there is no upper-level categories of the categories identified in S32, the classification may be carried out in accordance with the similarity between the target relevant information and the category relevant information, as in the second or third example embodiments.

In S34, the web search section 203A conducts a web search for information on the target data acquired in S31 and outputs the search result to the relevant information acquiring section 203. The relevant information acquiring section 203 acquires the search result, which is the target relevant information. For example, the relevant information acquiring section 203 may acquire a predetermined number of high-ranking ones of the search results and treat the same as the target relevant information.

In S35, the relevant information acquiring section 203 selects one category from among the plurality of categories identified in S32. In S36 that follows S35, the web search section 203A conducts a web search for information on the category selected in S35 and outputs the search result to the relevant information acquiring section 203. The relevant information acquiring section 203 acquires the search result, which is the category relevant information.

In S37, the web search section 203A conducts a web search for information relevant to the upper-level category (identified in S33) of the category selected in S35, and outputs the search result to the relevant information acquiring section 203. The relevant information acquiring section 203 acquires the search result, which is the upper-level category relevant information.

In S38, the similarity calculating section 204 calculates a similarity between the target relevant information acquired in S34 and the category relevant information acquired in S36, and also calculates a similarity between the target relevant information acquired in S34 and the upper-level category relevant information acquired in S37. In S39, the similarity calculating section 204 calculates an overall similarity from the similarities calculated in S38.

In S40, the relevant information acquiring section 203 determines whether the calculation of an overall similarity is completed for all of the plurality of categories identified in S32. When it is determined that the calculation is completed (YES in S40), the processing proceeds to the process of S41. Otherwise, when it is determined that the calculation of an overall similarity is not completed (NO in S40), the relevant information acquiring section 203 returns the processing to the process of S35 and selects one category which is not yet used for the calculation of an overall similarity.

In S41, the classifying section 205 classifies the target data into the category for which the overall similarity is the highest of the plurality of categories identified in S32. With this, the classification method of FIG. 11 ends.

As above, a configuration employed in the information processing apparatus 2B in accordance with the fourth example embodiment is the configuration in which, when a plurality of categories which are classification destinations are organized in a hierarchical structure, the classifying section 205 classifies target data into one of the plurality of categories in accordance with a similarity between target relevant information and category relevant information and an upper-level similarity indicating an extent to which the target relevant information is similar to upper-level category relevant information.

Accordingly, with the information processing apparatus 2B in accordance with the fourth example embodiment, it is possible to obtain an example advantage of being capable of classifying the target data into an appropriate category even in a case where the appropriate category cannot be identified only in accordance with the similarity between the target relevant information and the category relevant information, in addition to the example advantage yielded by the information processing apparatus 1 in accordance with the first example embodiment.

This is because in a case where the categories are organized in a hierarchical structure, when the target data is successfully classified into a correct category, the similarity between the target relevant information and the upper-level category relevant information is highly likely to be high. Assume that, for example, the correct classification of the target data “Tapi-tea” is “Tea” in the upper-level category and “Tapioca milk tea” in the lower-level category. In this case, the similarity between the relevant information on “Tapi-tea” (target relevant information) and the relevant information on “Tea” (upper-level relevant information) is high.

For example, in the above example, assume that there is a classification “Tapioca sour” in the lower-level category. In this case, a similarity between the relevant information on “Tapi-tea” and the relevant information on “Tapioca sour” is not different from or can be higher than the similarity between the relevant information on “Tapi-tea” and the relevant information on “Tapioca milk tea”. Even in such a case, if the upper-level category of “Tapioca sour” is, for example, “Alcohol”, the similarity of the relevant information on “Tapi-tea” to the relevant information on “Alcohol” is expected to be lower than the similarity of the relevant information on “Tapi-tea” to the relevant information on “Tea”. Thus, the classification in accordance with the upper-level similarity enables “Tapi-tea” to be correctly classified into “Tapioca milk tea”.

### (Variation)

In the information processing apparatus 2A in accordance with the third example embodiment and the information processing apparatus 2B in accordance with the fourth example embodiment, the search result of searching the relevant information DB 212 may be treated as the relevant information, as in the information processing apparatus 2 in accordance with the second example embodiment. Note that the relevant information as used here is any or all of the target data relevant information, the category relevant information, and the upper-level category relevant information.

In the information processing apparatus 2A and the information processing apparatus 2B, both the web search result and the search result of searching the relevant information DB 212 may be treated as the relevant information. In the information processing apparatus 2B, in a case where the search result of searching the relevant information DB 212 is treated as the relevant information, the web search section 203A may be omitted.

In each of the above example embodiments, a similarity between the target data and the category may be calculated, so that the target data is classified in consideration of the similarity. For example, a similarity between the target data name and the category name may be calculated in accordance with the communality, etc. of character strings included in the names.

Any agent may carry out each process described in the above example embodiments, and is not limited to the examples described above. In other words, it is possible to construct an information processing system having the same functions as those of the information processing apparatuses 1, 2, 2A, and 2B, with use of a plurality of apparatuses capable of mutual communication. For example, an information processing system having the same functions as those of the information processing apparatuses 2, 2A, and 2B can be constructed, by dispersedly providing blocks in a plurality of respective apparatuses, the blocks being illustrated in FIGS. 3, 6, and 9.

### [Software Implementation Example]

Some or all of the functions of each of the information processing apparatuses 1, 2, 2A, and 2B may be implemented by hardware such as an integrated circuit (IC chip), or may be implemented by software.

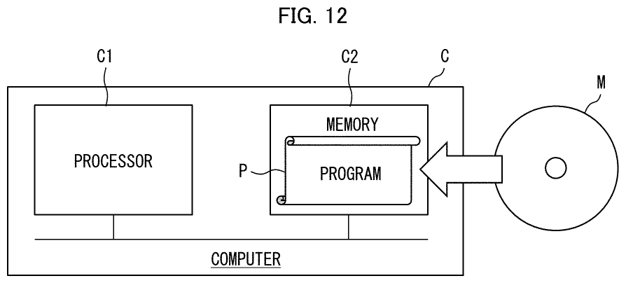

In the latter case, the information processing apparatuses 1, 2, 2A, and 2B are implemented by, for example, a computer that executes instructions of a program that is software implementing the foregoing functions. An example (hereinafter, computer C) of such a computer is illustrated in FIG. 12. The computer C includes at least one processor C1 and at least one memory C2. The memory C2 stores a program P for causing the computer C to operate as the information processing apparatuses 1, 2, 2A, and 2B. The processor C1 of the computer C retrieves the program P from the memory C2 and executes the program P, so that the functions of the information processing apparatuses 1, 2, 2A, and 2B are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

The computer C may further include a random access memory (RAM) in which the program P is loaded when executed and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be stored in a computer C-readable, non-transitory, and tangible storage medium M. Examples of such a storage medium M can include a tape, a disk, a card, a semiconductor memory, and a programmable logic circuit. The computer C can obtain the program P via the storage medium M. Alternatively, the program P can be transmitted via a transmission medium. Examples of such a transmission medium can include a communication network and a broadcast wave. The computer C can also obtain the program P via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following example aspects.

### (Supplementary Note 1)

An information processing apparatus including: a data acquiring means for acquiring target data, which is data to be classified into one of a plurality of categories; and a classifying means for classifying the target data into one of the plurality of categories in accordance with a similarity indicating an extent to which target relevant information relevant to the target data is similar to category relevant information relevant to each of the plurality of categories. With this configuration, it is possible to automatically classify the target data without use of a classifier constructed by machine learning.

### (Supplementary Note 2)

The information processing apparatus described in supplementary note 1, further comprising: a relevant information acquiring means for acquiring a search result of search for information on the target data and also acquiring a search result of search for information on each of the plurality of categories, the search result of search for information on the target data being the target relevant information, the search result of search for information on each of the plurality of categories being the category relevant information; and a similarity calculating means for calculating the similarity indicating a degree to which the search result indicated by the target relevant information is similar to the search result indicated by the category relevant information, the classification means being configured to classify the target data into a category of the plurality of categories, the category corresponding to the category relevant information for which the similarity is the highest. With this configuration, it is possible to appropriately classify the target data.

### (Supplementary Note 3)

The information processing apparatus described in supplementary note 2, in which: the target relevant information indicates search results which are acquired by searching for information on the target data and which range from a high-ranking search result to a low-ranking search result; the category relevant information indicates search results which are acquired by searching for information on each of the plurality of categories and which range from a high-ranking search result to a low-ranking search result; and the similarity calculating means is configured to calculate the similarity in accordance with an extent to which each of the search results that are indicated by the target relevant information and that range from the high-ranking search result to the low-ranking search result is similar to each of the search results that are indicated by the category relevant information and that range from the high-ranking search result to the low-ranking search result. With this configuration, it is possible to increase the accuracy of the similarity. In addition, even in a case where the target relevant information and the category relevant information contain search results that are poorly relevant to the target data and/or the category, it is possible to calculate a reasonable similarity as a whole.

### (Supplementary Note 4)

The information processing apparatus described in supplementary note 3, in which: in calculating the similarity, the similarity calculating means is configured to assign a greater weight to an extent to which high-ranking search results are similar to each other than to an extent to which low-ranking search results are similar to each other. With this configuration, it is possible to increase the accuracy with which a reasonable similarity is calculated.

### (Supplementary Note 5)

The information processing apparatus described in any one of supplementary notes 1 to 4, in which: the plurality of categories are organized in a hierarchical structure; and the classifying means is configured to classify the target data into one of the plurality of categories in accordance with the similarity and an upper-level similarity that indicates an extent to which the target relevant information relevant to the target data is similar to an upper-level category relevant information relevant to an upper-level category of each of the plurality of categories. With this configuration, it is possible to classify the target data into an appropriate category even in a case where the appropriate category cannot be identified only in accordance with the similarity between the target relevant information and the category relevant information.

### (Supplementary Note 6)

A classification method including: at least one processor acquiring target data, which is data to be classified into one of a plurality of categories; and the at least one processor classifying the target data into one of the plurality of categories in accordance with a similarity indicating an extent to which target relevant information relevant to the target data is similar to category relevant information relevant to each of the plurality of categories. With this configuration, it is possible to automatically classify the target data without use of a classifier constructed by machine learning.

### (Supplementary Note 7)

A classification program for causing a computer to function as: a data acquiring means for acquiring target data, which is data to be classified into one of a plurality of categories; and a classifying means for classifying the target data into one of the plurality of categories in accordance with a similarity indicating an extent to which target relevant information relevant to the target data is similar to category relevant information relevant to each of the plurality of categories. With this configuration, it is possible to automatically classify the target data without use of a classifier constructed by machine learning.

### [Additional Remark 3]

Some or all of the foregoing example embodiments can further be expressed as follows.

An information processing apparatus including at least one processor, the at least one processor carrying out: a process of acquiring target data, which is data to be classified into one of a plurality of categories; and a process of classifying the target data into one of the plurality of categories in accordance with a similarity indicating an extent to which target relevant information relevant to the target data is similar to category relevant information relevant to each of the plurality of categories.

This information processing apparatus may further include a memory. The memory may store a classification program for causing the processor to carry out the process of acquiring the target data and the process of classifying the target data into one of the plurality of categories. This classification program may be stored in a computer-readable, non-transitory, and tangible storage medium.

### REFERENCE SIGNS LIST

1: Information processing apparatus
11: Data acquiring section (data acquiring means)
12: Classifying section (classifying means)
2, 2A, 2B: Information processing apparatus
201: Data acquiring section (data acquiring means)
203: Relevant information acquiring section (relevant information acquiring means)
204: Similarity calculating section (similarity calculating means)
205: Classifying section (classifying means)

What is claimed is:

1. An information processing apparatus comprising
at least one processor, the at least one processor carrying out:
a data acquiring process of acquiring target data, which is data to be classified into one of a plurality of categories; and
a classifying process of classifying the target data into one of the plurality of categories in accordance with a similarity indicating an extent to which target relevant information relevant to the target data is similar to category relevant information relevant to each of the plurality of categories.

2. The information processing apparatus according to claim 1, wherein
the at least one processor further carries out:
a relevant information acquiring process of acquiring a search result of search for information on the target data and also acquiring a search result of search for information on each of the plurality of categories, the search result of search for information on the target data being the target relevant information, the search result of search for information on each of the plurality of categories being the category relevant information; and
a similarity calculating process of calculating the similarity indicating a degree to which the search result indicated by the target relevant information is similar to the search result indicated by the category relevant information, and
in the classifying process, the target data is classified into a category of the plurality of categories, the category corresponding to the category relevant information for which the similarity is the highest.

3. The information processing apparatus according to claim 2, wherein:
the target relevant information indicates search results which are acquired by searching for information on the target data and which range from a high-ranking search result to a low-ranking search result;
the category relevant information indicates search results which are acquired by searching for information on each of the plurality of categories and which range from a high-ranking search result to a low-ranking search result; and
in the similarity calculating process, the at least one processor calculates the similarity in accordance with an extent to which each of the search results that are indicated by the target relevant information and that range from the high-ranking search result to the low-ranking search result is similar to each of the search results that are indicated by the category relevant information and that range from the high-ranking search result to the low-ranking search result.

4. The information processing apparatus according to claim 3, wherein
in calculating the similarity, in the similarity calculating process, the at least one processor assigns a greater weight to an extent to which high-ranking search results are similar to each other than to an extent to which low-ranking search results are similar to each other.

5. The information processing apparatus according to claim 1 wherein:
the plurality of categories are organized in a hierarchical structure; and
in the classifying process, the at least one processor classifies the target data into one of the plurality of categories in accordance with the similarity and an upper-level similarity that indicates an extent to which the target relevant information relevant to the target data is similar to an upper-level category relevant information relevant to an upper-level category of each of the plurality of categories.

6. A classification method comprising:
at least one processor acquiring target data, which is data to be classified into one of a plurality of categories; and
the at least one processor classifying the target data into one of the plurality of categories in accordance with a similarity indicating an extent to which target relevant information relevant to the target data is similar to category relevant information relevant to each of the plurality of categories.

7. A computer-readable, non-transitory storage medium storing a program for causing a computer to carry out:
a data acquiring process of acquiring target data, which is data to be classified into one of a plurality of categories; and
a classifying process of classifying the target data into one of the plurality of categories in accordance with a similarity indicating an extent to which target relevant information relevant to the target data is similar to category relevant information relevant to each of the plurality of categories.
